(19) United States
(12) Patent Application Publication
(10) Pub. No.: US 2009/0135828 A1
(43) Pub. Date: May 28, 2009

(54) INTERNET PROTOCOL TELEVISION (IPTV) BROADCASTING SYSTEM WITH REDUCED DISPLAY DELAY DUE TO CHANNEL CHANGING, AND METHOD OF GENERATING AND USING ACCELERATION STREAM

(75) Inventors: Jae-cheol SIM, Daejeon (KR); Kee-seong CHO, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/243,569

(22) Filed: Oct. 1, 2008

(30) Foreign Application Priority Data
Nov. 27, 2007 (KR) 10-2007-0121599

(51) Int. Cl. H04L 12/56; H04N 7/173

(52) U.S. Cl. 370/394; 725/117; 725/131

(57) ABSTRACT

An Internet Protocol Television (IPTV) broadcasting system is provided. The IPTV broadcasting system includes: An Internet Protocol Television (IPTV) broadcasting system for reducing a display delay when a channel is changed, including: a stream transmitting apparatus receiving a broadcast channel stream, generating an acceleration stream from the broadcast channel stream, and transmitting the broadcast channel stream and the acceleration stream; and a set-top box receiving the broadcast channel stream and the acceleration stream from the stream transmitting apparatus, and reproducing a decoding stream, according to a type of a received frame in the broadcast channel stream and the acceleration stream. Therefore, it is possible to reduce a display delay when a channel is changed.

### CROSS REFERENCE TO RELATED APPLICATIONS

This application claims priority from Korean Patent Application No. 10-2007-0121599, filed on Oct. 5, 2007, the disclosure of which is incorporated herein in its entirety by reference.

### BACKGROUND OF THE INVENTION

1. Field of the Invention

The present invention relates to an Internet Protocol Television (IPTV) broadcasting system, and more particularly, to an Internet Protocol Television (IPTV) broadcasting system that reduces display delay due to channel changing using an acceleration stream, and a method of generating and restoring an acceleration stream.

This work was partly supported by the IT R&D program of MIC/IITA [2006-S-058-02, Development of Control Architecture for ALL-IP Integrated Network Service].

2. Description of the Related Art

In an Internet Protocol Television (IPTV), a broadcasting headend encodes a movie using a compression technique such as the MPEG-2 or MPEG-4 standard, and transmits the encoded movie to a set-top box according to a transmission format such as a Moving Picture Experts Group-Transport stream (MPEG-TS).

In the MPEG compression technique, in order to obtain a high compression rate, frames constructing a movie are compressed using different compression methods. Frames are classified into I, B, and P frames according to compression methods.

An I frame is obtained by compressing a whole still image, and B and P frames are obtained by compressing only the differences between two successive frames. As a result, B and P frames can have a compression rate higher than that of an I frame.

However, if no I frame exists, it is impossible to restore an image only using B and P frames.

In a movie, I, B and P frames are repeated according to a predetermined rule. A frame group in which B and P frames follow an I frame is called a Group of Picture (GOP). Here, the size of GOP can be defined as the number of frames constructing a GOP. Generally, the size of GOP is set to a number of frames corresponding to about 0.5 to 1 seconds, however, the size can be set to a number of frames corresponding to 1 or more seconds in order to obtain a higher compression rate.

For example, in an IPTV, a broadcast channel is encoded based on the MPEG standard, and transmitted in a multicast stream to a plurality of set-top boxes via routers on an Internet Protocol (IP) network. If a user of a set-top box selects a specific broadcast channel, the set-top box participates in a multicast tree via which the corresponding broadcast channel is transmitted, thus receives a multicast stream. Thus, the set-top box receives a broadcast channel stream for the specific broadcast channel, decodes the broadcast channel stream, and displays the decoded images on a screen. Here, since the user selects the specific channel at an arbitrary time, the set-top box does not always receive first an I frame. If a B or P frame is first received, the set-top box cannot display any image on the screen until any I frame is received. If the size of GOP corresponds to about 1 second, a screen will be displayed, in the worst case, in 1 second after channel changing.

When the size of GOP is larger, a higher compression rate is achieved, and the required network bandwidth can be lowered, however, as explained above, there is a longer delay in displaying a screen when a channel is changed.

In order to resolve the problem, mechanisms to deliver an I frame to a set-top box as quickly as possible have been proposed.

In one such conventional mechanism, a server transmits a broadcast channel stream in a multicast method and stores the broadcast channel stream. When a set-top box changes a channel, the server additionally transmits to the set-top box part of the stored broadcast channel stream from the latest I frame of the stored broadcast channel stream, in a unicast method. The conventional mechanism reduces the delay from the channel changing to the I frame reception, but the additional traffic is linearly increased as the number of set-top boxes requiring channel changing increases.

### SUMMARY OF THE INVENTION

The present invention provides a method of reducing a delay in displaying a screen when a channel is changed, in an Internet Protocol (IP) Television network using multicast technologies, thereby minimizing an increase in bandwidth to improve network bandwidth efficiency.

According to an aspect of the present invention, there is provided an Internet Protocol Television (IPTV) broadcasting system for reducing a display delay when a channel is changed, including: a stream transmitting apparatus receiving a broadcast channel stream, generating an acceleration stream from the broadcast channel stream, and transmitting the broadcast channel stream and the acceleration stream; and a set-top box receiving the broadcast channel stream and the acceleration stream from the stream transmitting apparatus, and reproducing a decoding stream with selecting frames used for decoding from the received streams, according to a type of a received frame.

According to another aspect of the present invention, there is provided a method of generating an acceleration stream to reduce a display delay when a channel is changed, the method including: grouping frames in a group of picture (GOP) of a broadcast channel stream into a plurality of groups; generating a plurality of interim groups including a predetermined number of groups among the plurality of groups; generating an acceleration channel stream by combining the plurality of interim groups; and synchronizing and outputting the broadcast channel stream and the acceleration channel stream generated by the acceleration channel stream generator.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a configuration diagram of an Internet Protocol Television (IPTV) network according to an embodiment of the present invention;

FIG. 2 is a block diagram of a stream transmission apparatus and a set-top box according to an embodiment of the present invention;

FIG. 3 is a view for explaining a method of generating an acceleration stream, according to an embodiment of the present invention;

FIG. 4 is a flowchart of a method of generating an acceleration stream, according to an embodiment of the present invention;

FIGS. 5A and 5B are a flowchart of a method of reproducing a decoding stream, according to an embodiment of the present invention; and

FIG. 6 is a flowchart of a method of reproducing a decoding stream when an acceleration stream is no longer received.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

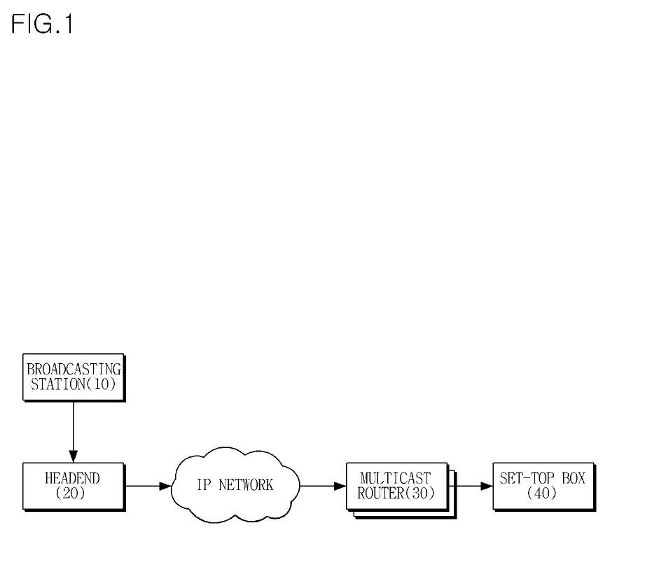

FIG. 1 is a configuration diagram of an Internet Protocol Television (IPTV) network according to an embodiment of the present invention. As illustrated in FIG. 1, the IPTV network includes a broadcasting station 10, a headend 20, multicast routers 30, and a set-top box 40.

The broadcasting station 10 sends the broadcast channel streams through ground waves, satellites, wire broadcasting, or an IP network. In the current embodiment of the present invention, a broadcast channel stream can be based on the MPEG-TS (Moving Picture Experts Group-Transport Stream) standard.

The headend 20 receives a broadcast channel stream in real time from the broadcasting station 10, generates a broadcast channel stream and an acceleration stream for each channel, and transmits the broadcast channel stream to the multicast routers 30 in real time.

The broadcast channel stream for each channel is a sequence of IP packets containing audio and video data encoded based on the MPEG-TS standard or any other streaming standard.

The multicast routers 30 establishes a multicast path from the set-top box 40 to the headend 20 of the corresponding channel, in response to a join message received from the set-top box 40, and relays the broadcast channel stream and the acceleration stream in a multicast manner to the set-top box 40.

The set-top box 40 receives a channel selection signal from a user, transmits a join message to the multicast router 30, and reproduces a decoding stream from the broadcast channel stream and the acceleration stream received from the multicast router 30. Then, the set-top box 40 decodes the decoding stream, and outputs the decoded images and sounds through a screen and a speaker.

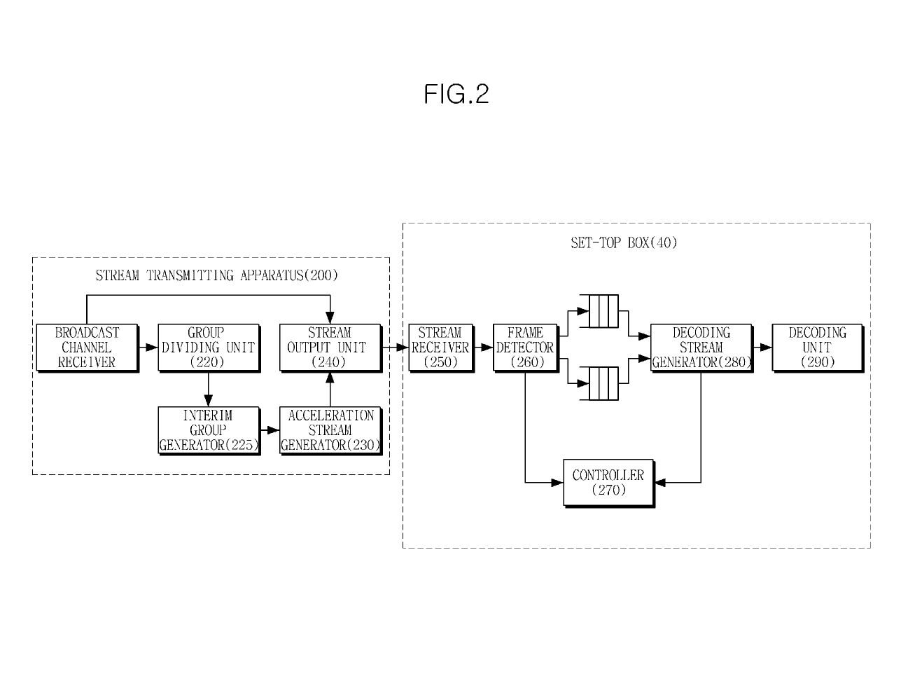

FIG. 2 is a block diagram of a stream transmitting apparatus 200 and a set-top box 40 according to an embodiment of the present invention.

The stream transmitting apparatus 200 generates an acceleration stream from a broadcast channel stream received from the broadcasting station 10, and transmits the broadcast channel stream and the acceleration channel stream together to the set-top box 40.

In detail, the stream transmitting apparatus 200 includes a broadcast channel receiver 210, a group dividing unit 220, an interim group generator 225, an acceleration stream generator 230, and a stream output unit 240.

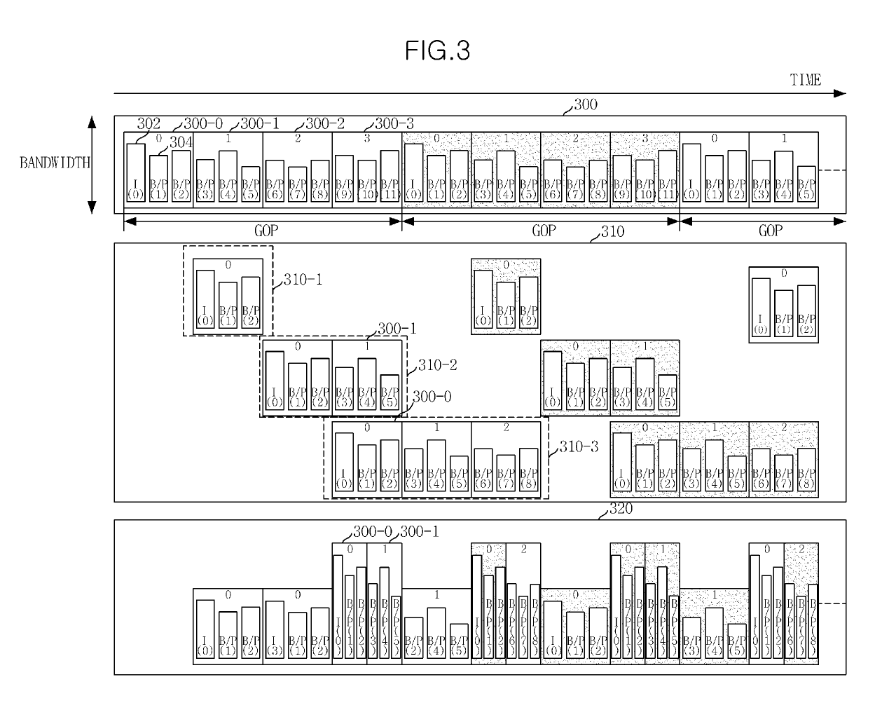

The broadcast channel receiver 210 receives a broadcast channel stream from a broadcasting station 10. Details for the group division unit 220, the interim group generator 225, the acceleration stream generator 230, and the stream output unit 240 will be described in detail with reference to FIG. 3.

FIG. 3 is a view for explaining a method of generating an acceleration stream, according to an embodiment of the present invention.

In the case of an IPTV service, audio, video, and data streams are multiplexed in a broadcast channel stream. However, in the current embodiment of the present invention, only video streams will be described with reference to FIG. 3.

Referring to FIGS. 2 and 3, the group dividing unit 220 groups frames in a group of picture (GOP) of a broadcast channel stream 300 received from the broadcast channel receiver 210 into N groups. In the current embodiment of the present invention, as illustrated in FIG. 3, it is assumed that a GOP is divided into four groups.

That is, the group dividing unit 220 groups frames in a GOP into four groups 300-0, 300-1, 300-2, and 300-3, and assigns group numbers 0, 1, 2, and 3 to the four groups 300-0, 300-1, 300-2, and 300-3, respectively. Here, the groups 300-0, 300-1, 300-2, and 300-3 may each include the same number of frames.

The interim group generator 225 generates the interim groups 310-1, 310-2, and 310-3 for the remaining groups 300-1, 300-2, and 300-3, except for the group 300-0 having the group number 0 among the groups 300-0, 300-1, 300-2, and 300-3 divided by the group dividing unit 220. Here, an interim group having a group number M includes groups having group numbers 0 through M−1 sequentially. For example, the interim group 310-1 of the group 300-1 having the group number 1 includes the group 300-0 having the group number 0. Also, the interim group 310-2 of the group 300-2 having the group number 2 includes the group 300-0 having the group number 0 and the group 300-1 having the group number 1 sequentially. Also, the interim group 310-3 of the group 300-3 having the group number includes the group 300-0 having the group number 0, the group 300-1 having the group number 1, and the group 300-2 having the group number 2 sequentially.

The acceleration stream generator 230 generates an acceleration stream 320 on the basis of the interim groups 310 generated by the interim group generator 225. The acceleration stream can be generated by sequentially arranging groups included in the interim groups 310. For example, groups that have to be transmitted during a time slot corresponding to the group 300-3 having the group number 3 are groups 300-1 and 300-0.

Accordingly, except for during time slot which an I frame is included in the broadcast channel stream, the acceleration stream includes an I frame for each time slot. As a result, by transmitting the broadcast channel stream and the acceleration stream together, the transmission interval of an I frame can be reduced to 1/N compared to a conventional technique which transmits only broadcast channel stream.

In a period where groups in a plurality of interim groups overlap in a time slot, the acceleration channel stream generator 230 increases a transmission bandwidth so that all overlapping groups are included in the corresponding time slot. The overlapping groups in the time slot are arranged such that their group numbers are in an ascending order. As seen in FIG. 3, the group 300-0 having the group number 0 precedes the group 300-1 having the group number 1.

The stream transmitting apparatus 200 can be installed in a headend of an IPTV broadcasting system, or can be installed in a multicast router.

Returning to FIGS. 1 and 2, the set-top box 40 includes a stream receiver 250, a frame detector 260, a controller 270, a decoding stream generator 280, and a decoding unit 290.

If a user selects a channel, the set-top box 40 accesses the headend 20 and acquires a multicast address of a broadcast channel stream for the selected channel. Also, the set-top box 40 acquires a multicast address of an acceleration stream corresponding to the broadcast channel stream.

The stream receiver 250 transmits a join message including multicast addresses of the broadcast channel stream and the acceleration stream to the multicast router 30, using the multicast addresses, and receives the broadcast channel stream and the acceleration stream from the multicast router 30.

The frame detector 260 analyzes the broadcast channel stream and the acceleration stream in real time, and determines whether a received packet includes an I frame. In the current embodiment of the present invention, if a received MPEG-TS is IP-packetized according to a real-time transport protocol (RTP) format defined in Request for Comments (RFC) 2250 of the Internet Engineering Task Force (IETF), the type of the corresponding frame can be determined from content written in the MPEG Video-specific header of the RTP header. If a received MPEG-TS is IP-packetized in any other format than the RTP format, the type of the corresponding frame can be determined on the basis of a Picture_Type field by interpreting a video elementary stream in the MPEG-TS.

Packets in which the presence of I frames has been determined by the frame detector 260 are stored in a broadcast channel stream buffer or an acceleration stream buffer.

The acceleration stream is obtained by copying and rearranging frames constituting the broadcast channel stream. Accordingly, the two streams have to be merged to a single stream for decoding, and the acceleration stream has to be received only as necessary in order to reduce a transmission bandwidth. For this, the controller 270 directs the decoding stream generator 280 to select packets included in the broadcast channel stream and the acceleration stream according to the determination results of the frame detector 260, and generate a decoding stream using the selected packets.

The controller 270 discards packets of the acceleration stream until I frame is detected. If an I frame is detected in the broadcast channel stream before detection in the acceleration stream, the controller 270 transmits a message (a Leave message) requesting to stop transmission of the acceleration stream, to the multicast router 30. Then, the controller 270 directs the decoding stream generator 280 to generate a decoding stream using the received broadcast channel stream. Meanwhile, if an I frame is detected in the acceleration stream before detection in the broadcast channel stream, the controller 270 directs the decoding stream generator 280 to generate a decoding stream using the received acceleration stream until the sequence number of the packet received from the acceleration stream is equal to the sequence number of the first packet of the broadcast channel stream. Then the controller 270 transmits a message (a Leave message) requesting to stop transmission of the acceleration stream, to the multicast router 30.

As illustrated in FIG. 3, the acceleration stream includes an I frame for each time slot, except for time slot in which I frames are included in the broadcast channel stream. Accordingly, even before no I frame is actually received through the broadcast channel stream, by selecting the I frames included in the acceleration stream, it is possible to start displaying a image.

When the controller 270 selects packets that are to be included in the decoding stream, the controller 270 selects the packets in the ascending order of their sequence numbers. That is, if the packet sequence number of a currently received acceleration stream packet is smaller than the packet sequence number of the previously received acceleration stream packet, the currently received acceleration stream packet is discarded.

The controller 270 can read a sequence number included in an RTP header of a received packet when the received packet has the RTP format. The decoding stream generator 280 sequentially arranges the packets selected by the controller 270, thereby generating the decoding stream.

The decoding unit 290 includes a decoder. The decoding unit 290 sequentially reads and decodes the packets of the decoding stream. Then, the decoding unit 290 displays video on the screen, and outputs sounds through a speaker.

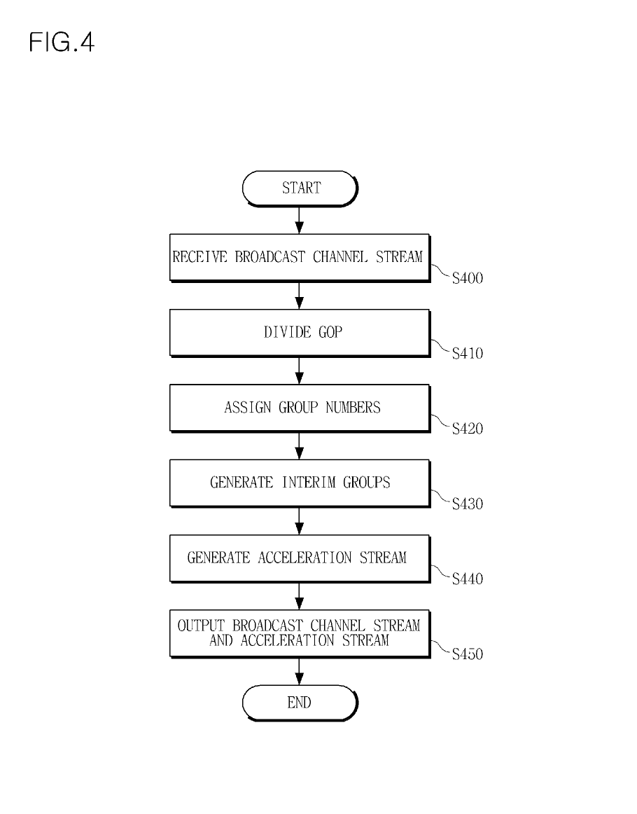

FIG. 4 is a flowchart of a method of generating an acceleration stream, according to an embodiment of the present invention

First, a broadcast channel stream is received from a broadcasting station (operation S400). Frames in a GOP of the broadcast channel stream is divided into N groups (operation S410), and group numbers 0, 1, 2, 3, . . . , N−1 are assigned to the N groups, respectively (operation S420). The N groups may each include the same number of frames.

Then, interim groups for the groups except for the group numbered 0 are generated (operation S430). For example, an interim group of a group having a group number M is a group in which groups having group numbers 0 through M−1 are sequentially arranged. And the beginning of the any interim group M is aligned with the group M in the broadcast channel stream.

Then, an acceleration stream is generated using the interim groups (operation S440). The acceleration stream can be generated by sequentially arranging the groups located in the same time slot in the interim groups. There is a time slot where a plurality of groups have to be transmitted in a time slot. That is, there is a period where groups in a plurality of interim groups overlap. In this case, by increasing a transmission bandwidth, the acceleration stream is generated in such a manner that all the overlapping groups of the interim groups are included in the time slot. The overlapping groups that are included in the time slot are arranged such that their group numbers are in an ascending order.

Then, the acceleration stream and the broadcast channel stream are synchronized and output.

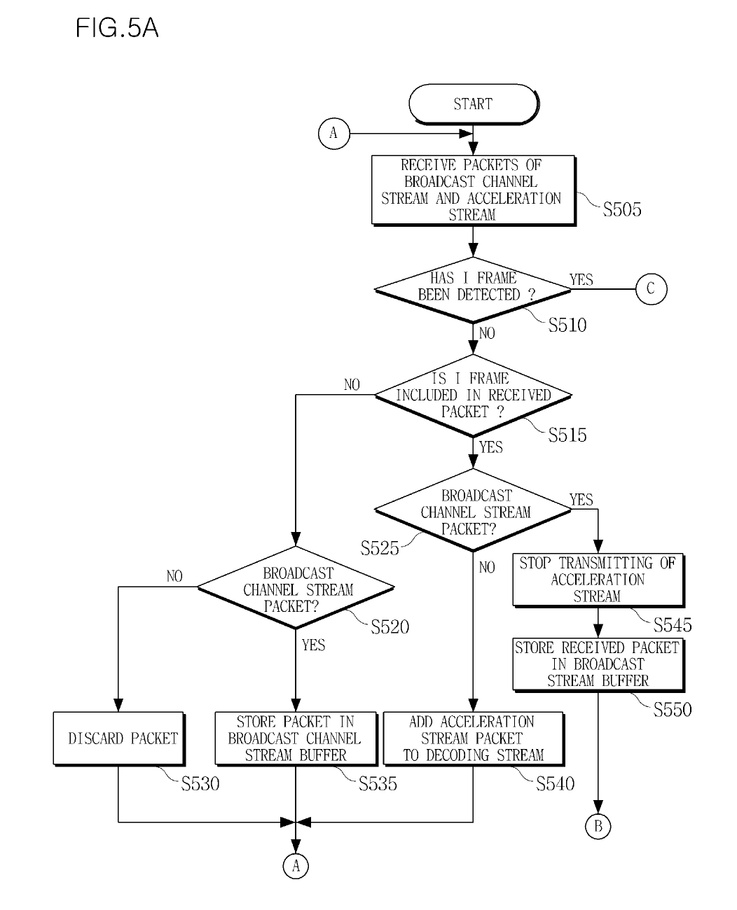

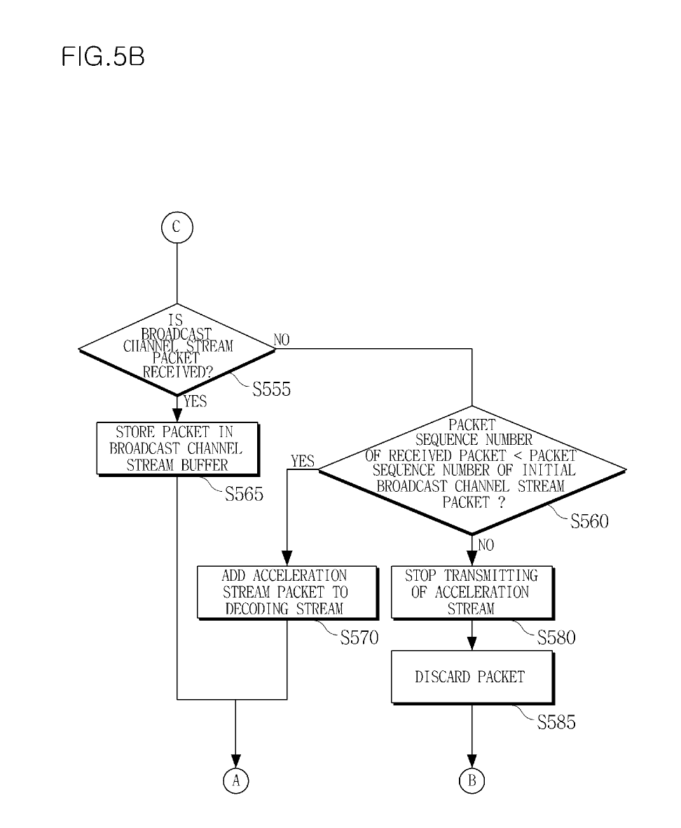

FIGS. 5A and 5B are a flowchart of a method of generating a decoding stream, according to an embodiment of the present invention.

The decoding stream generating method includes three stages: before a first I frame is detected; after the first I frame is detected; and after a request for stopping transmitting an acceleration stream is issued.

First, if a channel selection signal is received from a user, a multicast address for receiving an broadcast channel stream, and a multicast address for receiving an acceleration stream corresponding to the broadcast channel stream are acquired. A join message including the multicast addresses for the broadcast channel stream and the acceleration stream is transmitted, and packets of the acceleration stream and broadcast channel stream are received (operation S505).

Whenever a packet is received, it is determined whether any I frame has been detected from any one of the acceleration stream and the broadcast channel stream before the packet is received (operation S510). If no I frame has been detected from any one of the acceleration stream and the broadcast channel stream, it is determined whether an I frame is included in the received packet (operation S515). When an I frame is included in the received packet, if the received packet belongs to the broadcast channel stream (S525), a request for stopping transmitting the acceleration stream is issued (operation S545) and the received packet is stored in a IP stream buffer (operation S550). Meanwhile, if the received packet belongs to the acceleration stream, the received packet is added to a decoding stream (operation S540).

When no I frame is detected in the received acceleration stream and the broadcast channel stream, and also no I frame has been detected from any one of the acceleration stream and the broadcast channel stream, if the received packet belongs to the broadcast channel stream, the packet is stored in the broadcast channel stream buffer (operation S535). If the packet belongs to the acceleration stream, the packet is discarded (operation S530).

As a result, before an I frame is detected in the broadcast channel stream or the acceleration stream, all packets belonging to the broadcast channel stream are stored in the broadcast channel stream buffer, and packets belonging to the acceleration stream are all discarded.

If an I frame is already detected, it is determined whether the received packet belongs to the broadcast channel stream or to the acceleration stream (operation 555). If the received packet belongs to the broadcast channel stream, the received packet is stored in the broadcast channel stream buffer (operation S565). Meanwhile, if the received packet belongs to the acceleration stream, it is determined whether a sequence number of the received packet is smaller than a sequence number of an initially received broadcast channel stream packet (S560). If the sequence number of the received packet is smaller than the sequence number of the initially received broadcast channel stream packet, the received acceleration stream packet is added to a decoding stream (operation S570). If the sequence number of the received packet is equal to or greater than the packet sequence number of the initially received broadcast channel stream packet, a request for stopping transmitting the acceleration stream is issued (operation S580), and the received acceleration stream packet is discarded (operation S585). When the acceleration stream packet is added to the decoding stream (operation S570), the sequence number of the acceleration channel packet increases. That is, if the sequence number of the received acceleration stream packet is smaller than the packet sequence number of the previously received acceleration stream packet, the packet is discarded.

Accordingly, when a request for stopping transmitting the acceleration stream is issued (operations S545 and S580), if an I frame is first received from the acceleration stream, packets of the acceleration stream including from the I frame to frames received before a packet is initially received from the broadcast channel stream are included in the decoding stream.

Meanwhile, all packets received from the broadcast channel stream are stored in the broadcast channel stream buffer.

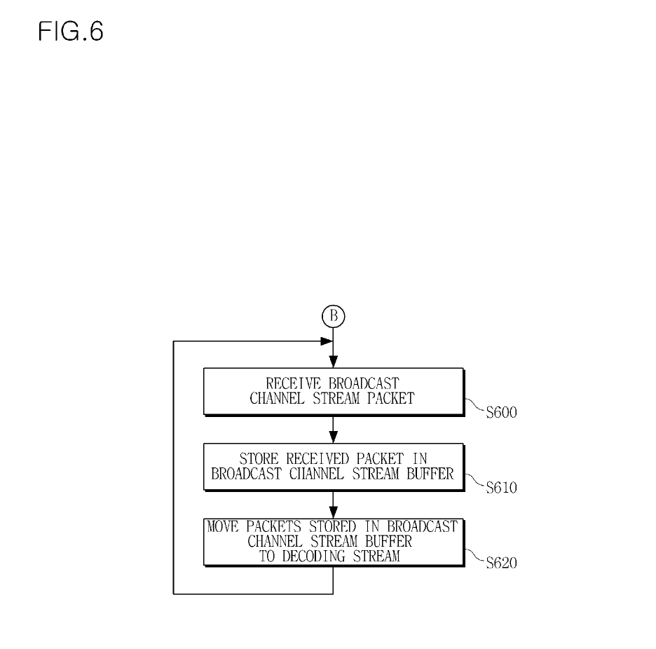

A method which is performed after a request for stopping transmitting an acceleration stream is issued will be described in detail with reference to FIG. 6.

FIG. 6 is a flowchart of a method of generating a decoding stream after reception of an acceleration stream is stopped, according to an embodiment of the present invention.

After a request for stopping transmitting an acceleration stream is issued, only a broadcast channel stream is received (operation S600). When a broadcast channel stream packet is received, the received broadcast channel stream packet is sequentially stored in the broadcast channel stream buffer (operation S610), and the broadcast channel stream buffer sequentially transfers packets stored therein to a decoding stream in the order in which the packets are received (operation S620). Accordingly, finally, the decoding stream is reproduced to include an I frame and the successive frames in a 1/N time interval of a GOP time interval, so that a decoding unit can perform decoding without extra processing.

Therefore, a broadcasting system according to an embodiment of the present invention can be applied to a digital content providing system providing compressed movie.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A stream transmitting apparatus of an Internet Protocol Television (IPTV) broadcasting system, for reducing a display delay when a channel is changed, comprising:
a group division unit receiving a broadcast channel stream and grouping frames in a group of picture (GOP) of the broadcast channel stream into a plurality of groups;
an interim group generator generating a plurality of interim groups including a predetermined number of groups among the plurality of groups;
an acceleration channel stream generating unit generating an acceleration channel stream by combining the plurality of interim groups; and
a stream output unit synchronizing and outputting the broadcast channel stream and the acceleration channel stream generated by the acceleration channel stream generator.

2. The stream transmitting apparatus of claim 1, wherein the interim group generator generates an interim group for at least one group among the plurality of groups, the interim group including one or more groups among the plurality of groups except for the at least one group.

3. The stream transmitting apparatus of claim 2, wherein the interim group generator generates an interim group for each of the plurality of groups, the interim group including all groups received before the each group is received.

4. The stream transmitting apparatus of claim 1, wherein the group division unit sequentially assigns group numbers to the plurality of groups, respectively, in an order in which the plurality of groups are received.

5. The stream transmitting apparatus of claim 4, wherein in a time slot in which groups in a plurality of interim groups overlap, the acceleration stream generating unit increases a transmission bandwidth to output all the overlapped groups in the plurality of interim groups during the time slot, and generates the acceleration stream so that the overlapped groups in the plurality of interim groups are all included in the time slot, wherein the overlapping groups of the plurality of interim groups are arranged such that group numbers in the time slot are in an ascending order.

6. The stream transmitting apparatus of claim 1, being a headend.

7. The stream transmitting apparatus of claim 1, being a multicast router.

8. A set-top box of an Internet Protocol Television (IPTV) broadcasting system, for reducing a display delay when a channel is changed, comprising:
a stream receiver receiving a broadcast channel stream and an acceleration stream from the stream transmitting apparatus;
a frame detector determining whether an Infra (I) frame is included in the broadcast channel stream or the acceleration stream;
a controller selecting a packet to be included in a decoding stream from the broadcast channel stream and the acceleration stream and requesting stop of the acceleration stream;
a decoding stream generator sequentially arranging a plurality of packets selected by the controller and generating a decoding stream; and
a decoding unit decoding the decoding stream.

9. The set-top box of claim 8, wherein, if no I frame is detected in the broadcast channel stream but an I frame is detected in the acceleration channel stream, the controller selects packets received from the acceleration stream while a sequence number of packet in the acceleration stream is less than a sequence number of the first packet in the broadcast channel stream.

10. The set-top box of claim 8, wherein, if a sequence number of a packet received from the acceleration stream is greater than or equal to a sequence number of the first packet received from the broadcast channel stream, a message for requesting the stream transmitting apparatus to stop transmission of the acceleration stream is issued.

11. A method of generating an acceleration stream to reduce a display delay when a channel is changed, the method comprising:
receiving a broad channel stream and grouping frames in a group of picture (GOP) of the broadcast channel stream into a plurality of groups;
generating a plurality of interim groups including a predetermined number of groups among the plurality of groups;
generating an acceleration channel stream by combining the plurality of interim groups; and
synchronizing and outputting the broadcast channel stream and the acceleration channel stream generated by the acceleration channel stream generator.

12. The method of claim 11, wherein the generating of the plurality of interim groups comprises generating an interim group for each of the plurality of groups, the interim group including all groups received before the each group is received.

13. The method of claim 11, after the receiving of the broad channel stream and the grouping of the frames into the plurality of groups, further comprising sequentially assigning group numbers to the plurality of groups, respectively, in an order in which the plurality of groups are received,
wherein the generating of the acceleration channel stream comprises, in a time slot in which groups in a plurality of interim groups overlap, increasing a transmission bandwidth to output all the overlapped groups in the plurality of interim groups during the time slot, and generating the acceleration stream so that the overlapped groups in the plurality of interim groups are all included in the time slot, wherein the overlapping groups of the plurality of interim groups are arranged such that group numbers in the time slot are in an ascending order.

14. A method of reproducing a decoding stream to reduce a display delay when a channel is changed, the method comprising:
receiving a broadcast channel stream and the acceleration stream;
determining whether any I frame is included in the broadcast channel stream or the acceleration stream;
if an I frame is detected in the broadcast channel stream or the acceleration stream, selecting packets received from the broadcast channel stream and the acceleration stream to be included in the decoding stream; and
reproducing the decoding stream with the selected packets.

15. The method of claim 14, wherein the selecting packets received from the broadcast channel stream and the acceleration stream to be included in the decoding stream comprises, if the I frame is detected in the broadcast channel stream before a detection in the acceleration stream, selecting packets received from the broadcast channel stream; and issuing a request to stop transmitting of the acceleration channel stream.

16. The method of claim 14, wherein the selecting packets received from the broadcast channel stream and the acceleration stream to be included in the decoding stream comprises, if no I frame is detected in the broadcast channel stream before an I frame is detected in the acceleration stream, selecting packets received from the acceleration stream in an ascending order of sequence numbers of the packets while a sequence number of the packet in the acceleration stream is less than a sequence number of the first packet in the broadcast channel stream.

17. The method of claim 16, wherein the determining of whether any I frame is included in the broadcast channel stream or the acceleration stream comprises recognizing a sequence number of a packet in the broadcast channel stream, and
the reproducing of the decoding stream comprises issuing a request to stop transmitting the acceleration channel stream if a sequence number of a packet received from the acceleration stream is greater than or equal to a sequence number of the first packet in the broadcast channel stream.
